(19) United States
(12) Patent Application Publication
(10) Pub. No.: US 2010/0239701 A1
(43) Pub. Date: Sep. 23, 2010

(54) Molding structure with independent thermal control and its molding method

(76) Inventors: Ren Haw Chen, Taipei City (TW); An Cheng Liou, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,639

(22) Filed: Mar. 20, 2009

(51) Int. Cl. B29C 35/00

(52) U.S. Cl. 425/143

(57) ABSTRACT

The present invention, in accordance with the shrinking behavior of heat-melt material during cooling and demolding of molding process, presents a molding structure with electrical heating lines embedded on the surface of the molding structure which allows the structure to provide independent thermal control. By allowing the mold to control its surface temperature, the thermal stress between the heat-melt material and the mold can be eliminated and balanced, thereby preventing the heat-melt material from damage by the gripping force during demolding process.

### BACKGROUND OF THE INVENTION

1. Field of the Invention

The present invention relates to a molding structure, and more particularly, a molding structure with independent thermal control which can eliminate thermal stress of heat-melt material during demolding process.

2. Description of the Related Art

Nano-science not only allows people to create more innovative and evolutionary product, it also brings new challenges to the micro-structure engineering. With advanced microstructure engineering, technology like semi-conductor, electro-optic, mechanic and bio-chemistry will be able to provide better performance and precision to their invention, the production cost can also be lowered at the same time. As part of micro-structure engineering, micro-molding is now a popular skill used by manufactures on creating micro-products, and among micro-molding, injection molding is one of the methods that are commonly used. Injection molding is a manufacturing technique for making parts from heat-melt materials like thermoplastic and thermosetting plastic in production. Molten plastic is injected at high pressure into a mold, which is the inverse of the product's shape. After the injection is done, the mold will then be cooled and the heat-melt material within it will be solidified, the finished product can then be fetched during demolding process.

However, as shown in FIG. 1 where a process of cooling and demolding is presented. The diagram on the left of FIG. 1 represents an equilibrium between heat-melt material and mold insert just after the injection. The middle diagram shows that as the mold insert cools down, due to the common property of any matter that is expanded when it is heated and it contracts when cooled, the heat-melt material will usually have 0.25-0.5% shrinkage rate during cooling process, which is also higher than mold insert. As a result, a strong gripping force will be created during the cooling process. If there is no proper mechanism for releasing this gripping force, heat-melt material especially materials that are the size of mirco structure will usually break during demolding process. Take a micro-structure with vertical wall thickness of 2 μm as example, the edge of a square product with 10 mm side length after cooling will shift (shrink) 5-10 times the thickness of the vertical wall. The shrinkage will create a strong gripping force and thereby making demolding process difficult with high chance of damaging the product. The main source of this problem is that the coefficient of thermal expansion for each material is different, thus thermal stress will usually occur at certain temperature depending on the material. The diagram on the right represents a successful releasing of the gripping force during demolding process, where the heat-melt material can be removed undamaged.

Therefore, to solve the above-mentioned problems, the present invention proposes a molding structure with independent thermal control, by embedding electrical heating line on the surface of the mold allows the mold to eliminate thermal stress of heat-melt material during demolding process.

### SUMMARY OF THE INVENTION

It is therefore one of the many objectives of the claimed invention to provide a molding structure with independent thermal control which can eliminate thermal stress of heat-melt material during demolding process.

According to the claimed invention, a molding structure with independent thermal control is disclosed. The structure includes a mold which allows heat-melt material to form shapes according to the mold shape; at least one electrical heating line embedded in the surface of the mold, the electrical heating line is conductive and is able to provide different temperature to the mold according to different input voltage; a power supply unit which provides the input voltage; and a control unit that controls the temperature of the electrical heating line by controlling the amount of the input voltage provided by the power supply unit, and during demolding process of the heat-melt material, the control unit eliminates thermal stress caused by difference between thermal expansion coefficient of the mold and the heat-melt material by adjusting the temperature of the mold.

Below, the embodiments of the present invention are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing filling, cooling and demolding of heat-melt material during molding process;

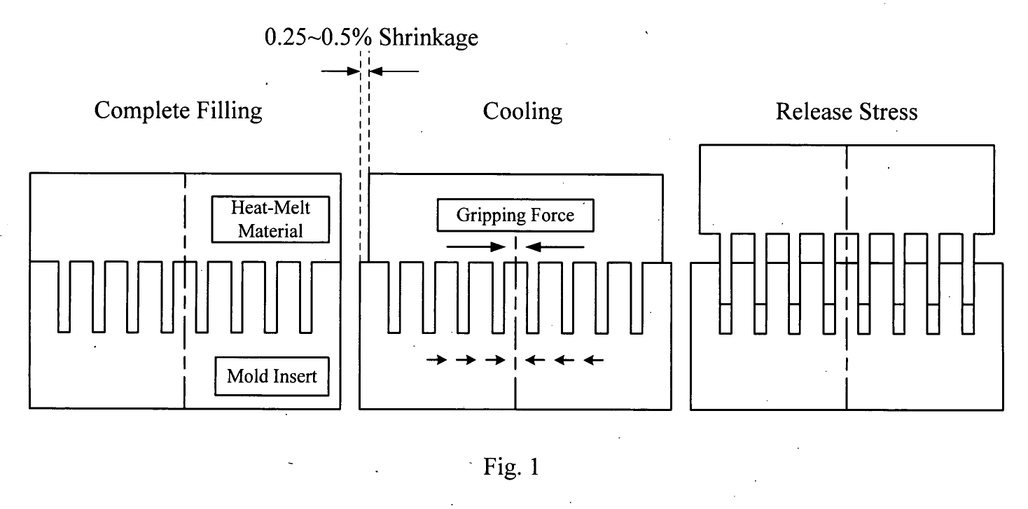

FIG. 2 is a diagram schematically showing an injection molding with independent thermal control;

FIG. 3 is a diagram schematically showing the process of demolding for injection molding with independent thermal control;

FIG. 4 is a diagram schematically showing a molding structure with electrical heating line embedded on the surface.

FIG. 5 is a diagram schematically showing the temperature change for heat-melt material during cooling and demolding process;

### DETAILED DESCRIPTION OF THE INVENTION

The present invention provides a molding structure with independent thermal control which allows the mold to eliminate thermal stress caused by the difference in coefficient of thermal expansion between the mold and heat-melt material.

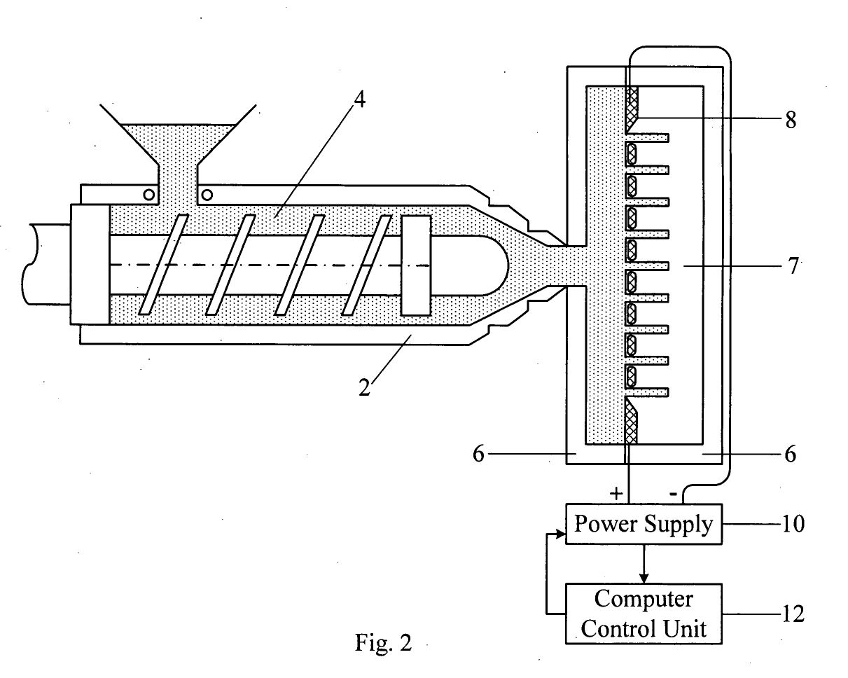

The present invention can be applied to any kind of molding method including hot embossing, injection molding, rolling and photo-polymerization. Please refer to FIG. 2 for one of the preferred embodiments of the present invention which takes injection molding as illustration. Since the independent thermal control requires output power of the power supply 10 to be controlled, an additional computer control unit 12 is required to perform this task. As mentioned before, injection molding is a manufacturing technique where heat-melt material 4 such as thermoplastic or thermosetting plastic materials is injected at high pressure into a molding structure by an injector 2. In order to provide the molding structure with independent thermal control, the molding structure of the present invention is mainly comprised by a mold 6, at least one electrical heating line 8, a power supply unit 10 and a control unit 12. The mold 6 allows heat-melt material 4 to be injected and form shapes according to user. On the surface of the mold 6, at least one electrical heating line 8 is embedded. The electrical heating line 8 is conductive and has the property of providing different temperature to contacting surface of the mold 6 depending on the input voltage. The contacting surface of the mold 6 mentioned above is the part where mold 6 contacts heat-melt material 4. The power supply unit 10 is responsible for providing the input voltage to the electrical heating line 8 and the control unit 12 is responsible for controlling the temperature of the electrical heating line 8 by controlling the amount of the input voltage provided by the power supply unit 10.

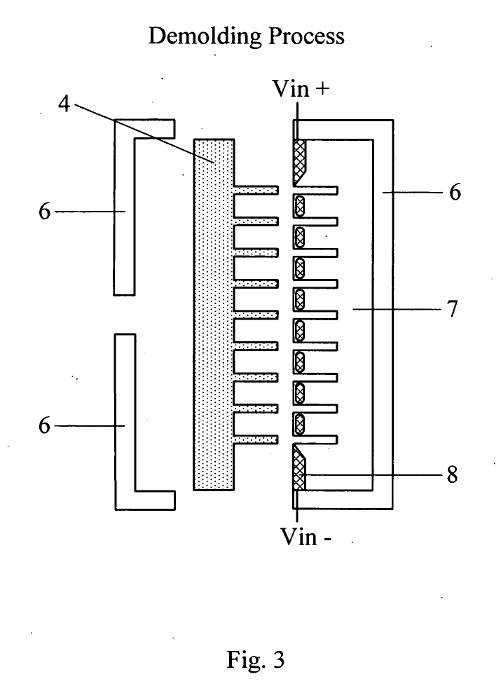

As shown in FIG. 3, where demolding process of the heat-melt material 4 is presented, with thermal control ability, the mold 6 can auto-adjust its temperature through computer control unit 12 to eliminates the thermal stress caused by difference in coefficient of thermal expansion between the mold 6 and the heat-melt material 4. For example, suppose the coefficient of thermal expansion (α) for heat-melt material 4 is X and it has freezing point (solidifying point) at 100° C. During cooling process, the temperature of the heat-melt material 4 will usually drop to a certain point depending on the cooling methods, however they are usually around room temperature 20 to 23.5° C. According to the equation for calculating volume thermal expansion,

$$\frac{Δ V}{{V}_{0}} = ανΔ T ,$$

where ΔT indicates the difference in temperature before and after cooling. As we can see, as ΔT increases, the volume shrinkage rate

$$\frac{Δ V}{{V}_{0}}$$

increases as well which means the bigger the ΔT, the larger the thermal stress. Therefore if the heat-melt material 4 is cooled to room temperature of 20° C. from 100° C. during cooling process, ΔT will be 80° C. Obviously, 80° C. of ΔT will result in a significant thermal stress and make demolding process difficult especially in micro-structure molding. However, by allowing the electrical heating line 8 on the contacting surface of mold 6 to raise the temperature of the heat-melt material 4 after or during cooling process, ΔT can be decreased to a very minimum point and thus the thermal stress can be eliminated. So molding method using mold with independent thermal control like present invention simply requires providing a mold with electrical heating lines embedded on the surface and during demolding process of heat-melt material, using these electrical heating lines to eliminate thermal stress caused by the temperature difference.

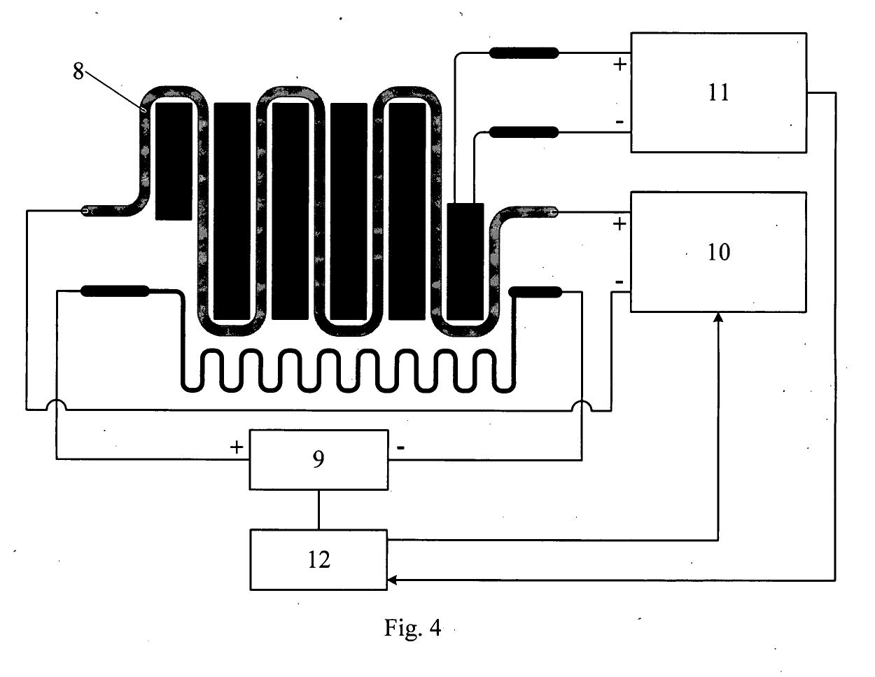

The present invention can also be applied to micro-structured mold and utilize silicon wafer, metal, ceramic or any other semi-conductor as its base material. Please refer to FIG. 4 for how electrical heating line 8 is dispersed and take a silicon wafer based micro-structured mold as another embodiment of the present invention. The process of embedding the electrical heating line 8 to the micro-structured mold can comprise the following: First, form a dielectric layer and a silicon nitride layer on a conductive silicon wafer mold. Then apply exposure, lithography and etching to mask the dielectric layer and use dry etching technique to etch the silicon wafer mold into an exothermal loop. After that, use ion implementation technique to implement conductive ions into borderline of said silicon wafer mold, then apply Gaussian distribution to vertical concentration of the ions so that ions can concentrate on the surface layer of the micro-structured mold, creating a bridge which allows electrons to move around, the movement of said electrons will generate heat and provide said silicon wafer mold different temperature, acting like an electrical heating line. Finally, apply photo-resist inverse technique to the ions to remove silicon dioxide and the silicon nitride, then remove the dielectric layer which is silicon dioxide of thermal oxidation and connect electrode of the ions to a power supply to realize a silicon wafer based micro-structured mold with independent thermal control. Additionally, the mentioned photo-resist inverse is being soft baked after the exposure, under the condition of not using filter to re-exposure again to achieve changing positive photo-resist into negative photo-resist. Furthermore, dry etching uses reaction ion etching technique to make photo-resist residue into a buffer layer mask. After those electrical heating lines 8 are being dispersed at designated areas, each electrical heating line 8 is connected to a power supply 10 and there are also thermal couples 11 adjacent to the electrical heating line 8. The thermal couples 11 will report the temperature surrounding the electrical heating line 8 to a computer control unit 12 and the computer control unit 12 will control the input power from power supply 10 to control the temperature of the designated areas. An additional pressure sensor 9 can also be included to detect the pressure subjected by the mold.

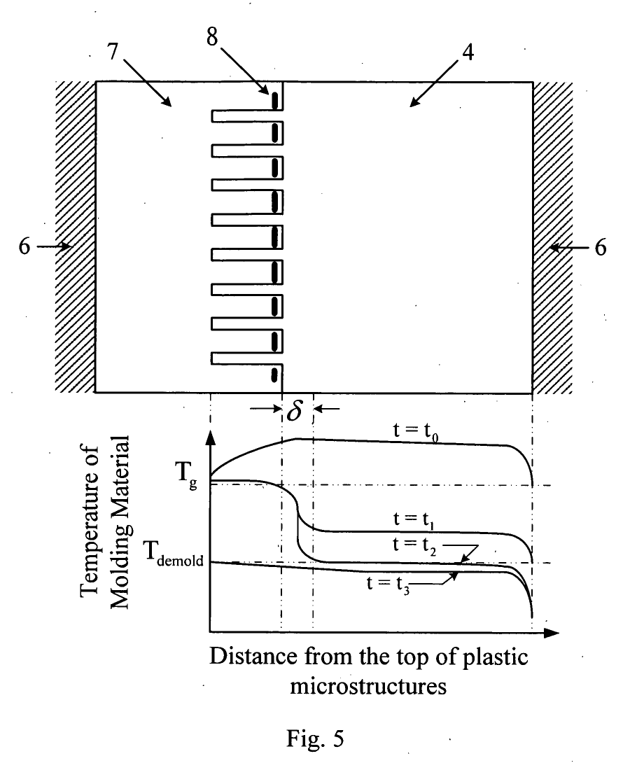

FIG. 5 is a new type of mold proposed by the present invention that can eliminate gripping force encountered by the prior art. It mainly utilizes implantation technology to allow designated areas within the mold insert 7 to be conductive such as creating multiple resistive power lines 8 parallel to the surface of designated areas. When an input power is provided, these resistive power lines 8 will generate heat and function like an electrical heater where their temperature can be easily controlled by the degrees of the input power. As a result, the overall temperature of contacting surface between the mold insert 7 and the heat-melt material 4 upon demolding process can also be controlled through this process, thereby balancing the thermal expansion between the mold insert 7 and the heat-melt material 4. In this preferred embodiment of the present invention, the interaction between heat-melt material 4 and the mold insert 7 is performed in a metallic mold plate 6 for best performance. The diagram on the bottom of FIG. 5 further illustrates the temperature distribution and solidifying time series for heat-melt material 4 mentioned above during cooling process (t=t₀˜t₃). When heat-melt material 4 enters cooling process (t=t₀) and is being cooled by the mold insert 7, two sides of the heat-melt material 4 will have lower temperature than the middle initially. When the cooling process reaches T_{g} point (highest solidifying temperature for the heat-melt material 4), the electrical heating line starts to generate heat (t=t₁) and the temperature for the surface of the left base of the heat-melt material 4 will be maintained above T_{g} point wherein the right base of the heat-melt material 4 continues to drop temperature. Before the cooling process reaches specified demolding temperature (t=t₂), temperature for the surface of the left base of the heat-melt material 4 still maintains above T_{g} point while other parts has already reached the specified demolding temperature (T_{demold}), the electrical heating line is still powering at this time. When the cooling process is finished (t=t₃) and the electrical heating line stops powering, temperature for the surface of the left base of the heat-melt material 4 will drop to demolding temperature and the demolding process can be proceed. δ represents the thickness of heat-melt material 4 where most temperature difference exists between the surface and the base of the heat-melt material 4. δ is also the part that will generate most gripping force during the cooling process and its gripping force can be calculated with the following equation:

$$F = δ \times L \times σ = δ \times L \times E \times ( {α}_{heat - melt - material} - {α}_{mold} ) \times ( \frac{{T}_{g} - {T}_{demold}}{2} )$$

Where F is the gripping force, L is the total thickness of the heat-melt material 4 product, σ is the thermal stress of the heat-melt material 4, E is Young's Modulus of heat-melt material 4 at demolding temperature, αₕₑₐₜ₋ₘₑₗₜ₋ₘₐₜₑᵣᵢₐₗ and α_{mold} are the coefficient of thermal expansion for heat-melt material 4 and the mold insert 7 respectively and lastly, T_{g} is the highest solidifying temperature for the heat-melt material 4 and T_{demold} represents demolding temperature.

Those described above are only the preferred embodiments to exemplify the present invention but not to limit the scope of the present invention. Any equivalent modification or variation according to the shapes, structures, features and spirit disclosed in the specification is to be also included within the scope of the present invention.

What is claimed is:

1. A molding structure with independent thermal control, said structure comprising:
a mold which allows heat-melt material to form shapes according to said mold shape;
at least one electrical heating line embedded in the surface of said mold, said electrical heating line is conductive and is able to provide different temperature to said mold according to different input voltage;
a power supply unit which provides said input voltage; and
a control unit that controls the temperature of said electrical heating line by controlling the amount of said input voltage provided by said power supply unit, and during demolding process of said heat-melt material, said control unit eliminates thermal stress caused by difference between coefficient of thermal expansion of said mold and said heat-melt material by adjusting the temperature of said mold.

2. The molding structure with independent thermal control of claim 1, wherein said mold includes micro-structured mold.

3. The molding structure with independent thermal control of claim 2, wherein said micro-structured mold can utilize silicon wafer, metal, ceramic or any other semi-conductor materials as its base material.

4. The molding structure with independent thermal control of claim 3, wherein manufacturing method of said silicon wafer based micro-structured mold with independent thermal control comprises:
forming a dielectric layer and a silicon nitride layer on a conductive silicon wafer mold;
applying exposure, lithography and etching to mask said dielectric layer, then use dry etching technique to etch said silicon wafer mold into an exothermal loop;
using ion implementation technique to implement conductive ions into borderline of said silicon wafer mold, then apply Gaussian distribution to vertical concentration of said ions so said ions can concentrate on surface layer, creating a bridge which allows electrons to move around, the movement of said electrons will generate heat and provide said silicon wafer mold different temperature;
applying photo-resist inverse technique to said ions to remove silicon dioxide and said silicon nitride; and
removing said dielectric layer and connect electrode of said ions to a power supply to realize a silicon wafer based micro-structured mold with independent thermal control.

5. The molding structure with independent thermal control of claim 4, wherein said photo-resist inverse is being soft baked after said exposure, under the condition of not using filter to re-exposure again to achieve changing positive photo-resist into negative photo-resist.

6. The molding structure with independent thermal control of claim 4, wherein said dry etching uses reaction ion etching technique to make photo-resist residue into a buffer layer mask.

7. The molding structure with independent thermal control of claim 4, wherein said dielectric layer is silicon dioxide of thermal oxidation.

8. The molding structure with independent thermal control of claim 1, wherein said heat-melt material include thermoplastic and thermosetting plastic materials.

9. A molding method using mold with independent thermal control, said method comprising:
providing a mold with electrical heating lines embedded on the surface, said electrical heating lines are conductive and able to provide different temperature to said mold according to different input voltage; and
during demolding process of heat-melt material, use said electrical heating lines to eliminate thermal stress caused by difference between coefficient of thermal expansion of said mold and said heat-melt material by adjusting temperature of said mold.

10. The molding structure with independent thermal control of claim 9, wherein said mold includes micro-structured mold.

11. The molding structure with independent thermal control of claim 10, wherein said micro-structured mold can utilize silicon wafer, metal, ceramic or any other semi-conductor materials as its base material.

12. The molding structure with independent thermal control of claim 11, wherein manufacturing method of said silicon wafer based micro-structured mold with independent thermal control comprises:
forming a dielectric layer and a silicon nitride layer on a conductive silicon wafer mold;
applying exposure, lithography and etching to mask said dielectric layer, then use dry etching technique to etch said silicon wafer mold into an exothermal loop;
using ion implementation technique to implement conductive ions into borderline of said silicon wafer mold, then apply Gaussian distribution to vertical concentration of said ions so said ions can concentrate on surface layer, creating a bridge which allows electrons to move around, the movement of said electrons will generate heat and provide said silicon wafer mold different temperature;
applying photo-resist inverse technique to said ions to remove silicon dioxide and said silicon nitride; and
removing said dielectric layer and connect electrode of said ions to a power supply to realize a silicon wafer based micro-structured mold with independent thermal control.

13. The molding structure with independent thermal control of claim 12, wherein said photo-resist inverse is being soft baked after said exposure, under the condition of not using filter to re-exposure again to achieve changing positive photo-resist into negative photo-resist.

14. The molding structure with independent thermal control of claim 12, wherein said dry etching uses reaction ion etching technique to make photo-resist residue into a buffer layer mask.

15. The molding structure with independent thermal control of claim 12, wherein said dielectric layer is silicon dioxide of thermal oxidation.

16. The molding structure with independent thermal control of claim 9, wherein said heat-melt material include thermoplastic and thermosetting plastic materials.
